(19) United States
(12) Patent Application Publication
(10) Pub. No.: US 2016/0124149 A1
(43) Pub. Date: May 5, 2016

(54) CONDITIONED LAUNCH OF A SINGLE MODE LIGHT SOURCE INTO A MULTIMODE OPTICAL FIBER

(71) Applicant: Avago Technologies General IP (Singapore) Pte. Ltd, Singapore (SG)

(72) Inventors: Ye Chen, San Jose, CA (US); An-Nien Cheng, San Jose, CA (US)

(21) Appl. No.: 14/529,738

(22) Filed: Oct. 31, 2014

(51) Int. Cl. G02B 6/14; G02B 5/32; G02B 6/32; G02B 6/34; H01S 3/00; G02B 6/42

(52) U.S. Cl. CPC G02B 6/14; H01S 3/0064; G02B 6/4206; G02B 6/4207; G02B 6/4255; G02B 6/32; G02B 6/34; G02B 5/32

(57) ABSTRACT

An optical coupling system and method are provided for coupling light from a single mode laser (SML) light source into an MMF that reduce back reflection of laser light into the SML light source and provide controlled launch conditions that allow the light to avoid defective areas in the MMF as the light travels in the MMF. The launch conditions are controlled to cause preselected spatial intensity distribution patterns to be launched into the MMF that result in the laser light avoiding defective areas in the MMF as the laser light passes through the MMF. The combination of all of these features allows greater link bandwidth and link length to be achieved with an MMF without increasing transceiver packaging complexity. In addition, because the preselected spatial intensity distributions allow the light to avoid particular areas in the fiber that are likely to contain defects, fiber manufacturers can focus less on reducing defects in those areas and focus more on optimization of performance parameters.

### TECHNICAL FIELD OF THE INVENTION

The invention relates to optical fiber networks and, more particularly, to using a single mode light source with a multimode optical fiber link to increase the bandwidth of the optical fiber link while also reducing back reflection and allowing the link length to be increased.

### BACKGROUND OF THE INVENTION

In optical communications networks, optical transceiver modules are used to transmit and receive optical signals over optical fibers. A transceiver module includes a transmitter side and a receiver side. On the transmitter side, a laser light source generates modulated laser light and an optical coupling system receives the modulated laser light and optically couples, or images, the light onto an end of an optical fiber. The laser light source typically comprises one or more laser diodes that generate light of a particular wavelength or wavelength range. A laser diode driver circuit of the transmitter side outputs electrical drive signals that modulate the laser diodes. The optical coupling system typically includes one or more reflective, refractive and/or diffractive elements. On the receiver side, optical signals passing out of the end of an optical fiber are optically coupled onto a photodiode by an optical coupling system of the transceiver module. The photodiode converts the optical signal into an electrical signal. Receiver circuitry of the receiver side processes the electrical signal to recover the data.

In high-speed data communications networks (e.g., 10 Gigabits per second (Gb/s) and higher), multimode optical fibers (MMFs) rather than single mode optical fibers (SMFs) are often used due to the lower implementation costs associated with MMFs (e.g., lower-cost connectors and lower maintenance costs). In such networks, certain link performance characteristics, such as the link transmission distance, for example, are dependent on properties of the laser light source and on the design of the optical coupling system. The link transmission distance, i.e., the length of an MMF link, is often limited by differential modal dispersion (DMD), chromatic dispersion (CD), and modal partition noise (MPN). DMD is introduced due to imperfections in the MMF whereas CD and MPD are introduced by the multimode light source.

The use of a single mode light source in an MMF link could eliminate CD and MPN impairments introduced by the multimode light source, thereby allowing greater MMF link length to be achieved. In addition, the use of a single mode light source in an MMF link makes it easier to maintain connectors and reduces the transceiver packaging complexity and costs. However, single mode light sources are more sensitive to back reflection than multimode light sources. In a data center MMF infrastructure, back reflection is inherent, especially where the MMF-transceiver interface is not terminated with a physical contact and the properties of connections are not tested.

The traditional approaches for managing back reflection include using an edge-emitting laser diode with a fixed-polarization output beam in conjunction with an optical isolator, or using an angular offset launch in which either an angled fiber in a pigtailed transceiver package or a fiber stub is used to direct the light from the light source onto the end face of the link fiber at a non-zero degree angle to the optical axis of the link fiber. All of these approaches have advantages and disadvantages. The optical isolator may not have the desired effect if used with a laser light source that has a variable-polarization output beam, such as a vertical cavity surface emitting laser diode (VCSEL). Using an angled fiber pigtail or fiber stub can increase the complexity and cost of the transceiver packaging.

Fiber imperfections that often cause DMD are center and edge defects in the refractive index profiles of MMFs. Such defects are generally due to the nature of the processes that are used to manufacture the MMFs. Various techniques are used to control the launch conditions for launching laser light into the end of the MMF to prevent the laser light from passing through the areas in the MMF where the defects are most severe and where the occurrences of defects are more frequent. For example, it is known to use a spatial offset launch to launch light into the end of the MMF in a way that allows the light to avoid at least some of the defects as it passes through the MMF. In a spatial offset launch, an optical offsetting device positioned between the laser light source and the end face of the MMF directs the light produced by the laser light source onto a location on the end face of the MMF that is spatially offset from the center of the MMF end face. For example, the optical offsetting device may be an optical fiber stub connected or optically coupled on one end to an end of the MMF and having an optical axis that is spatially offset from, but parallel to, the optical axis of the MMF. The light from the source passes through the stub and then into the end face of the MMF. Because the optical axes of the stub and of the MMF are offset, i.e., not coaxial, light passing out of the stub enters the end face of the MMF at a location that is spatially offset from the center of the MMF end face. If performed properly, a spatial offset launch of this type can result in the laser light avoiding center and edge defects as it passes through the MMF.

Other types of launches designed to avoid defects in the MMF are also known, such as, for example, spiral launches. A spiral launch involves using a spiral launch optical coupling system that encodes the laser light from the source with a phase pattern that rotates the phase of the light linearly around the optical axis of a collimating lens that is used to couple the light from the source onto the end face of the optical fiber. Rotating the phase of the laser light about the optical axis helps ensure that defects in the center of the fiber are avoided.

Therefore, although using a single mode laser light source with an MMF would provide advantages in terms of increased bandwidth, increased link length, and reduced transceiver packaging complexity, there are certain obstacles that need to be overcome. In particular, solutions to the problems of back reflection and MMF defects are needed. Accordingly, it would be desirable to provide an optical communications link that uses a single mode light source and an MMF in a way that allows higher bandwidth and greater link length to be achieved while also controlling launch conditions to manage back reflection and avoid defects in the MMF.

### SUMMARY OF THE INVENTION

The invention is directed to an optical transmitter module and methods that use a single mode light source and an MMF in a way that allows higher bandwidth and greater link length to be achieved while also controlling launch conditions to manage back reflection and avoid defects in the MMF. The optical transmitter comprises a single mode light source and an optical coupling system. The single mode light source produces a light beam that is received by the optical coupling system. The optical coupling system is configured to receive the light beam, convert the light beam into light having a preselected spatial intensity distribution pattern, and direct the light having the preselected spatial intensity distribution pattern toward an end face of the MMF. The preselected spatial intensity distribution pattern is preselected to avoid one or more areas in the MMF that are likely to contain defects when the light having the preselected spatial intensity distribution pattern travels through the MMF.

In accordance with an embodiment, the method comprises the following. With a single mode light source, a light beam is produced. With an optical coupling system, the light beam is converted into light having a preselected spatial intensity distribution pattern and the light having the preselected spatial intensity distribution pattern is directed onto an end face of an MMF. The preselected spatial intensity distribution pattern is preselected to avoid one or more areas in the MMF that are likely to contain defects when the light having the preselected spatial intensity distribution pattern travels through the MMF.

In accordance with another embodiment, the method comprises the following. An optical coupling system is disposed in between a first end face of the MMF and the single mode light source, where the optical coupling system is designed to convert the light beam into light having a preselected spatial intensity distribution pattern and to reduce back reflection of light from the first end face of the MMF into an aperture of the single mode light source. The preselected spatial intensity distribution pattern is preselected to avoid one or more areas in the MMF that are likely to contain defects. With the optical coupling system, the light beam is received, converted into light having the preselected spatial intensity distribution pattern, and directed onto the first end face of an MMF.

These and other features and advantages of the invention will become apparent from the following description, drawings and claims.

### BRIEF DESCRIPTION OF THE DRAWINGS

FIG. 1 illustrates a block diagram of an optical transmitter that includes a single mode laser (SML) light source and an optical coupling system.

FIG. 2 illustrates a schematic diagram of the optical transmitter shown in FIG. 1 with the optical coupling system of the transmitter shown in FIG. 1 having a particular physical structure.

FIG. 3 illustrates a schematic diagram of the optical transmitter shown in FIG. 1 with the optical coupling system of the transmitter shown in FIG. 1 having a particular physical structure that is different from the physical structure shown in FIG. 2.

FIG. 4 illustrates a plan view of a launch condition created by a conventional refractive optical coupling system at an end face of an MMF.

FIG. 5 illustrates a plan view of a launch condition created by the optical coupling system shown in FIG. 2 or 3 at an end face of an MMF.

FIG. 6 illustrates a plan view of a launch condition created by the optical coupling system shown in FIG. 2 or 3 at an end face of an MMF.

FIG. 7 illustrates a plan view of back reflected optical power directed back into the aperture of a SML light source by a conventional refractive optical coupling system.

FIG. 8 illustrates a plan view of back reflected optical power that has been decentralized by the optical coupling system shown in FIG. 2 or 3 so as not to be incident on the aperture of the SML light source 2.

FIG. 9 illustrates a plan view of back reflected optical power that has been decentralized by the optical coupling system shown in FIG. 2 or 3 so as not to be incident on the aperture of the SML light source 2.

FIG. 10 illustrates a plan view of a phase pattern of a first side of the optical coupling system shown in FIG. 2 in accordance with an illustrative embodiment in which the first side of the optical coupling system is implemented as an analog freeform surface combined with a refractive lens to achieve a spatial intensity distribution pattern of the type shown in FIG. 5.

FIG. 11 illustrates a plan view of the first side of the optical coupling system shown in FIG. 3 in accordance with an illustrative embodiment in which the first side of the optical coupling system is implemented as a diffractive surface combined with a refractive surface to achieve the spatial intensity distribution pattern of the type shown in FIG. 5.

FIG. 12 illustrates a plan view of the first side of the optical coupling system shown in FIG. 3 in accordance with another illustrative embodiment in which the first side of the optical coupling system is implemented as a holographic phase pattern combined with a refractive lens to achieve the spatial intensity distribution pattern of the type shown in FIG. 6.

### DETAILED DESCRIPTION OF AN ILLUSTRATIVE EMBODIMENT

In accordance with the illustrative, or exemplary, embodiments described herein, an optical coupling system and method are provided for coupling light from a single mode laser (SML) light source into an MMF in a way that reduces back reflection of laser light into the SML light source and provides controlled launch conditions that allow the laser light to avoid defective areas in the MMF as the light travels through the MMF. The launch conditions are controlled to cause preselected spatial intensity distribution patterns to be launched into the MMF that cause the laser light to avoid defective areas in the MMF as the light passes through the MMF. The combination of these features allows greater link bandwidth and link length to be achieved with an MMF without increasing transceiver packaging complexity.

In accordance with one illustrative embodiment, the optical coupling system comprises a first optical element that reduces back reflection and a second optical element that couples laser light from the SML light source into the end of an MMF. The first and second optical elements may be formed in a single, unitary piece of optical material or they may be separate elements formed in separate pieces of optical material and then secured together. For illustrative purposes, the optical elements are shown as being formed in opposite sides of a single, unitary piece of optical material.

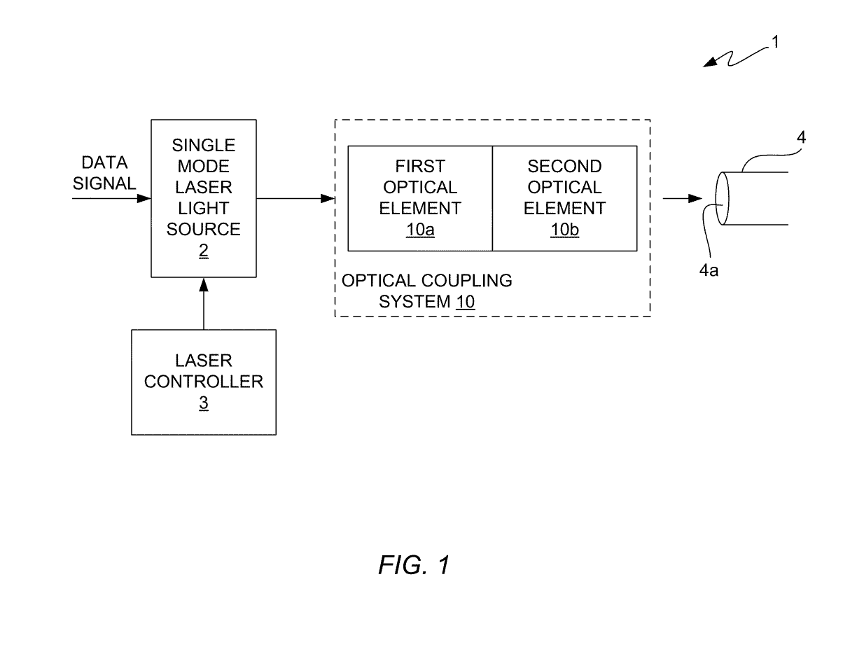

The optical coupling system is disposed along an optical pathway that extends between an output facet of the SML light source and an end face of the MMF. In accordance with the illustrative embodiments described herein, the first and second optical elements of the optical coupling system are positioned relative to the SML light source and the end face of the MMF such that laser light emitted from the output facet of the SML light source encounters the first optical element before encountering the second optical element. The first optical element reduces back reflection to the SML light source while converting the light into a preselected spatial intensity distribution pattern. The second optical element launches, projects or images the preselected spatial intensity distribution pattern onto the end face of the MMF. Because of the preselected spatial intensity distribution of the laser light, the laser light avoids defects in the MMF. The spatial intensity distribution pattern is preselected based on known or likely defective areas in the MMF to ensure that the laser light launched into the MMF avoids the defective areas as it travels in the MMF. Illustrative, or exemplary, embodiments will now be described with reference to FIGS. 1-12, in which like reference numerals represent like components, elements or features.

FIG. 1 illustrates a block diagram of an optical transmitter 1 that includes a single mode laser (SML) light source 2 and an optical coupling system 10. The optical transmitter 1 is typically part of an optical transceiver module (not shown) that also includes an optical receiver (not shown). The term “optical transmitter,” as that term is used herein, is intended to mean a transmitter having components for generating an optical signal for transmission over an optical waveguide.

The SML light source 2 is modulated by an electrical data signal to produce an optical data signal. In accordance with this illustrative embodiment, an optional laser controller 3 controls the operations of the light source 2 by controlling bias and modulation currents that are provided to the light source 2. The optical transmitter may include additional elements or components that are not shown for clarity and for ease of illustration. The laser light that is produced by the SML light source 2 is received by the optical coupling system 10 and coupled, or launched, by the optical coupling system 10 into the end of an MMF 4.

The optical coupling system 10 includes first and second optical elements 10a and 10b that are designed to manage back reflection and to provide a controlled launch that causes the light to avoid areas in the MMF that contain defects as the light travels through the MMF. For example, it is generally known that MMFs contain center and edge defects. Therefore, as will be described below in more detail, the controlled launch can project or image a preselected spatial intensity distribution pattern of the laser light onto the end face 4a of the MMF 4 that will ensure that the laser light avoids the center and edge defective areas in the MMF 4 as it travels through the MMF 4. The manner in which the first and second optical elements 10a and 10b are designed and manufactured to achieve these objectives is described below in detail.

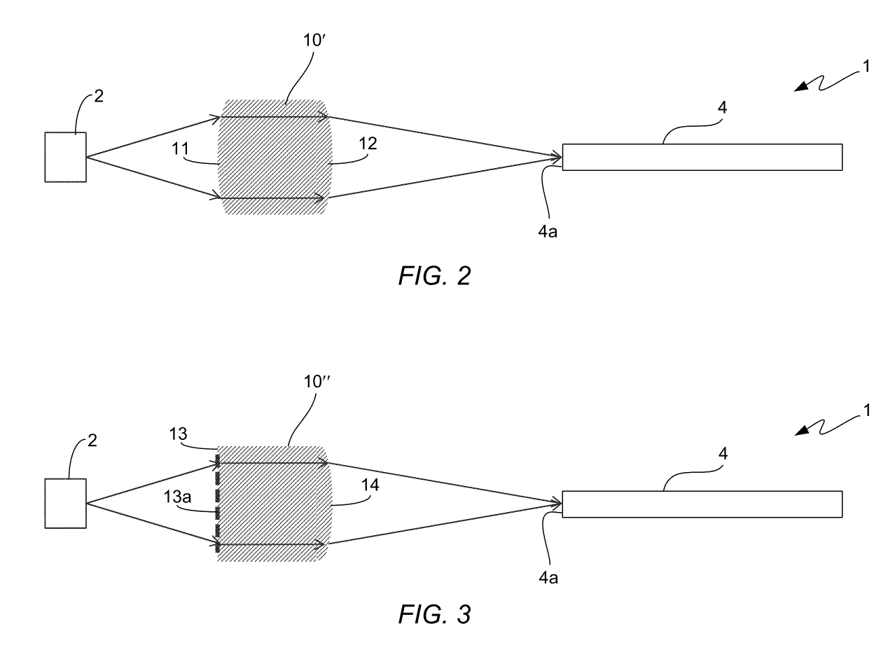

FIGS. 2 and 3 illustrate schematic diagrams of illustrative embodiments of the optical transmitter 1 shown in FIG. 1 without the controller 3. In accordance with the illustrative embodiment shown in FIG. 2, the optical coupling system 10′ of the optical transmitter 1 is a unitary, or integrally-formed, part having a first side 11 that is an analog freeform surface corresponding to the first optical element 10a shown in FIG. 1 and having a second side 12 that is also an analog freeform surface corresponding to the second optical element 10b shown in FIG. 1. In accordance with the illustrative embodiment shown in FIG. 3, the optical coupling system 10″ of the optical transmitter 1 is a unitary, or integrally-formed, part having a first side 13 that is a diffractive surface corresponding to the first optical element 10a shown in FIG. 1 and having a second side 14 that is an analog freeform surface corresponding to the second optical element 10b shown in FIG. 1. In both of these embodiments, the second optical elements 12 and 14 are refractive or collimating lenses, although they could be other types of optical elements.

The freeform surfaces of the first and second sides 11 and 12 of the optical coupling system 10″ are defined by preselected mathematical formulas. The first side 11 is designed to reduce back reflection below, or maintain it at, a particular decibel (dB) level while also converting the laser light into a predetermined spatial intensity distribution pattern. The second side 12 is designed to operate on the laser light in a predetermined manner to optically couple the predetermined spatial distribution of the laser light onto the end face 4a of the MMF 4.

The optical coupling system 10′ shown in FIG. 2 is typically made by using a molding process to injection mold a moldable optical material, such as a thermoplastic material, or by using an epoxy replication process to replicate the surfaces 11 and 12 in epoxy. The optical molding material or the epoxy used in these processes is transparent to the operating wavelength of light emitted by the SML light source 2. A diamond turning process may also be used to create the optical coupling system 10′.

The first side 13 of the optical coupling system 10″ shown in FIG. 3 is a diffractive pattern or a holographic pattern. The first side 13 is designed to reduce back reflection below, or maintain it at, a particular dB level while also converting the laser light into a predetermined spatial intensity distribution pattern of laser light. The second side 14 is designed to couple the predetermined spatial intensity distribution pattern of laser light onto the end face 4a of the MMF 4.

The optical coupling system 10″ shown in FIG. 3 is typically made of glass or silicon. The diffractive or holographic pattern is formed in a surface 13a of the first side 13 and is typically created using photolithographic processes (i.e., photoresist patterning to form a mask and then etching the unmasked areas). Similary, the second side 14 can be fabricated through a photolithographic patterning and etching process. Aternatively, a master of the diffractive or holographic pattern formed in surface 13a can be generated using a photolithographic process and then the master can be used in a molding process or an epoxy replication process to replicate the optical coupling system 10″ in plastic or epoxy. The second optical element 14 of the optical coupling system 10″ shown in FIG. 3 may be identical to the second optical element 12 of the optical coupling system 10′ shown in FIG. 2 and may be formed in the manner described above with reference to FIG. 2.

It should be noted that the invention is not limited with respect to the processes or materials that are used to make the optical coupling system 10, 10′ and 10″. As will be understood by persons of skill in the art, a variety of processes and materials are suitable for making the optical coupling system 10, 10′ and 10″. The processes and materials described above are merely a few examples of suitable processes and materials that may be used for this purpose.

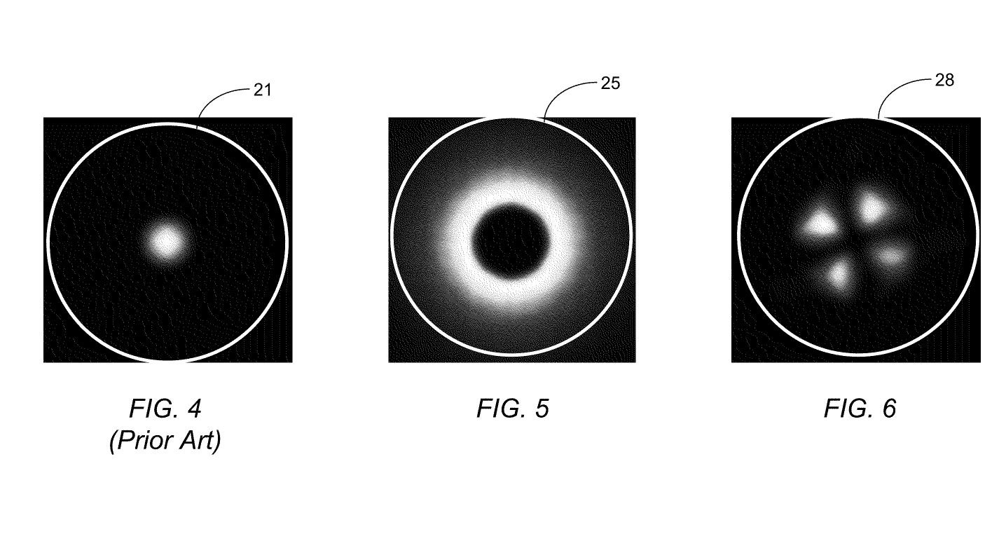

FIG. 4 illustrates a plan view of a launch condition created by a conventional refractive optical coupling system at an end face of a typical MMF. The circle 21 represents a 50 micrometer core of a typical MMF. It can be seen that the brightest region in the view shown in FIG. 4 is optical energy focused at the center of the core 21, which is where defects in the MMF often exist. Encounters between the laser light traveling through the MMF and such defects lead to DMD, which, as discussed above, leads to reductions in bandwidth and link length.

FIG. 5 illustrates a plan view of a launch condition created by the optical coupling system 10′ or 10″ shown in FIGS. 2 and 3, respectively, at the end face 4a of the MMF 4. The circle 25 represents a 50 micrometer core of the MMF 4, although the core of the MMF 4 can have other diameters. The brightest region in the view shown in FIG. 5 is a predetermined spatial intensity distribution pattern created by the predetermined launch condition provided by the optical coupling system 10′ or 10″. It can be seen that the spatial intensity distribution pattern is decentralized relative to the center of the core 25, i.e., it is outside of the core 25. It can also be seen that the spatial intensity distribution pattern is inward of the edge of the core 25, which is where defects often exist in MMFs. Thus, most of the optical energy avoids any center and edge defects in the MMF 4.

FIG. 6 illustrates a plan view of a launch condition created by the optical coupling system 10′ or 10″ shown in FIGS. 2 and 3 at the end face 4a of the MMF 4. The circle 28 represents the 50 micrometer core of the MMF 4. It can be seen that the predetermined spatial intensity distribution pattern disperses optical energy in multiple regions surrounding, but outside of, the center of the core 28. The pattern is also inward of the edge of the core 28. Thus, most of the optical energy avoids any center and edge defects in the MMF 4.

It should be noted that while FIGS. 5 and 6 illustrate two predetermined spatial intensity distribution patterns that avoid certain areas in the MMF 4, the optical coupling system 10 can be designed and manufactured to achieve any desired spatial intensity distribution pattern. The patterns shown in FIGS. 5 and 6 are used as examples due to the fact that it is generally known that MMFs are susceptible to having center and edge defects, which are avoided by the patterns shown in FIGS. 5 and 6.

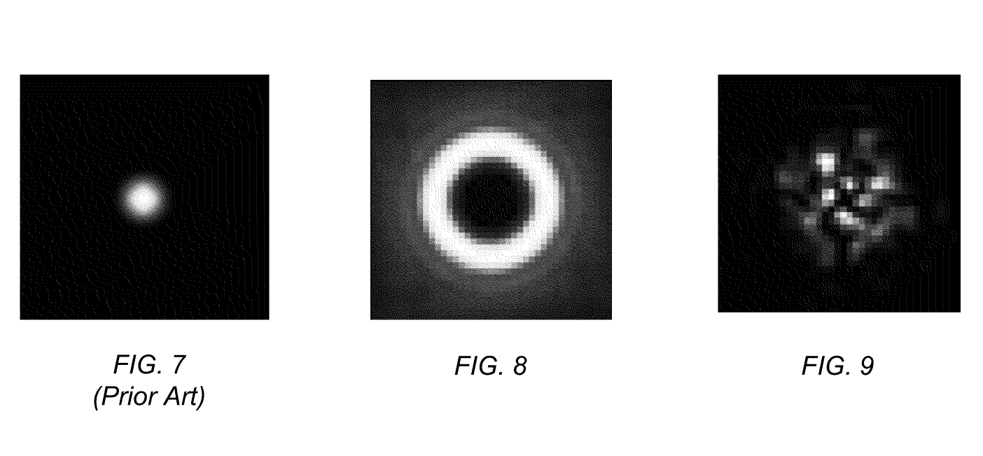

FIG. 7 illustrates a plan view of back reflected optical power directed back into the aperture of a SML light source by a conventional refractive optical coupling system. Because the back reflected light is centralized, most of the light enters the aperture of the SML light source. FIG. 8 illustrates a plan view of back reflected optical power decentralized by the optical coupling system 10′ or 10″ shown in FIG. 2 or 3 to prevent most of the back reflected optical energy from being directed back into the aperture of the SML light source 2. FIG. 9 illustrates a plan view of back reflected optical power decentralized and dispersed by the optical coupling system 10′ or 10″ shown in FIG. 2 or 3 to prevent most of the back reflected optical energy from being directed into the aperture of the SML light source 2. Thus, it can be seen that the optical coupling systems 10′ and 10″ also achieve the goals of reducing the dB level of optical power that is directed into the aperture of the SML light source 2 in addition to simultaneously providing a spatial intensity distribution pattern that avoids defective areas in the MMF.

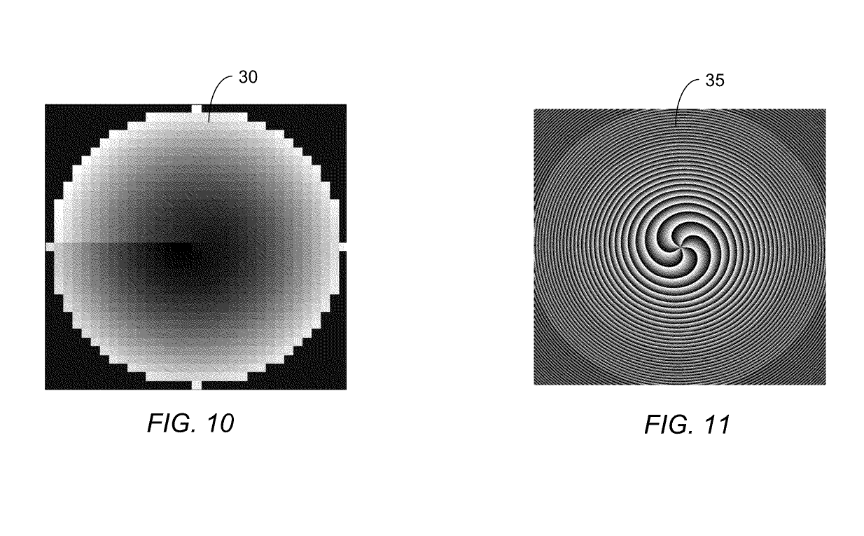

FIG. 10 illustrates a plan view of the first side 11 of the optical coupling systems 10′ shown in FIG. 2 in accordance with an illustrative embodiment in which the first side 11 is implemented as an analog freeform surface 30 combined with a refractive lens to achieve a spatial intensity distribution pattern similar to that shown in FIG. 5. The analog freeform surface 30 is defined by a phase pattern having phase values that range from −2π to +2π, with −2π corresponding to the smallest phase delay in the laser light created by the freeform surface 30 and +2π corresponding to the greatest phase delay in the laser light created by the freeform surface 30. The phase values are calculated as:

Phase Value=M×Φ, Equation 1

where M is a constant, typically an integer, and Φ is the azimuth angle of a polar coordinate system having a Z-axis corresponding to the optical axis of the optical coupling system 10′.

In accordance with the illustrative embodiment of FIG. 10, the analog freeform surface 30 converts the laser light received from the SML light source 2 into a spatial intensity distribution pattern similar to the pattern shown in FIG. 5. An example of an analog freeform surface that is capable of achieving this type of spatial intensity distribution pattern is a vortex lens. Simultaneously, the analog freeform surface 30 provides decentralized back reflection similar to that shown in FIG. 8.

FIG. 11 illustrates a plan view of the first side of the optical coupling system 10″ shown in FIG. 3 in accordance with an illustrative embodiment in which the first side 13 of the optical coupling system 10″ is implemented as a diffractive surface 35 combined with a refractive lens to achieve the spatial intensity distribution pattern shown in FIG. 5. The diffractive surface 35, which corresponds to surface 13a shown in FIG. 3, comprises a phase pattern made up of phase values that range from 0 to 2π. As discussed above, an optical coupling system that performs a spiral launch is one that encodes the laser light from the source with a phase pattern that rotates the phase of the light linearly around the optical axis of a collimating lens. Spiral launches are generally effective at avoiding center and edge defects in an MMF fiber. In accordance with this illustrative embodiment, the predetermined spatial intensity pattern produced by the diffractive pattern formed in diffractive surface 13a encodes the light from the SML light source 2 linearly around the optical axis of the optical coupling system 10″. The refractive lens of the second side 14 directs the encoded light onto the end face 4a of the MMF 4. In this way, the optical coupling system 10″ achieves the spatial intensity distribution pattern shown in FIG. 5 to avoid center and edge defects in the MMF 4 while simultaneously providing dispersed back reflection similar to that shown in FIG. 9.

The spiral launch is an example of a controlled launch that generates a predetermined spatial intensity distribution that avoids center and edge defects in the MMF 4, but other types of controlled launches that have the effect of avoiding other defective areas in the MMF 4 may be also be used. As indicated above, the optical coupling system 10 can be designed and manufactured to achieve any desired spatial intensity distribution launch of laser light onto the end face 4a of the MMF 4. Therefore, as long as it is known in advance where the defective areas in the MMF are most likely located, the optical coupling system 10 can be designed and manufactured to achieve the desired launch conditions to ensure that the laser light avoids those areas as it propagates in the MMF.

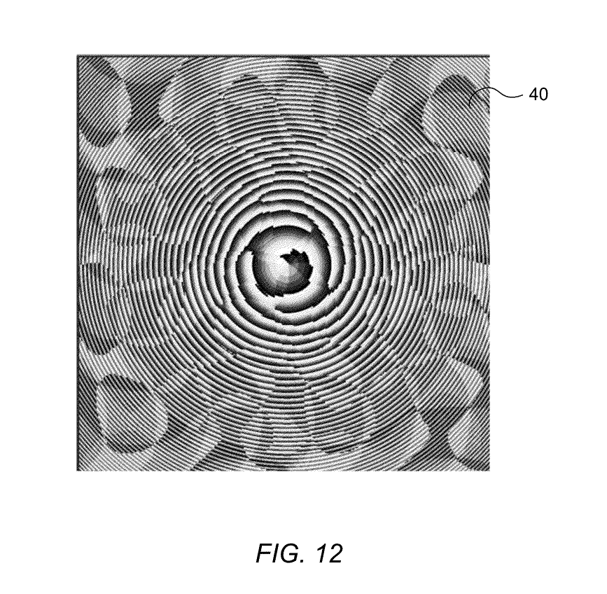

FIG. 12 is a plan view of a screen shot of an illustrative embodiment of a holographic pattern 40 formed in the surface 13a of the first side 13 of the optical coupling system 10″ (FIG. 3) combined with a refractive lens that is also formed in the first side 13. The holographic pattern 40 is designed based on a computer-generated hologram that is capable of producing a preselected spatial intensity distribution pattern that reduces back reflection in the way depicted in FIG. 9 while simultaneously providing a controlled launch in the way depicted in FIG. 6 into the MMF 4 that avoids defective areas in the MMF 4.

Like the phase pattern 35 shown in FIG. 11, in accordance with this illustrative embodiment, the holographic pattern 40 provides a spiral launch of the laser light emitted by the SML light source 2. Thus, in accordance with this illustrative embodiment, the diffractive pattern 40 encodes the laser light from the source 2 with a phase that rotates the light linearly around the optical axis of the optical coupling system 10″, thereby ensuring that defects in the center and near the edge of the MMF 4 are avoided.

The surface 13a having the holographic pattern 40 formed therein is typically designed as follows. One or more algorithms are performed that generate spatial intensity distribution patterns. One of the generated spatial intensity distribution patterns is then selected based on its effectiveness at avoiding defective areas in the MMF 4. In accordance with this illustrative embodiment, the spatial intensity distribution pattern is selected based on its effectiveness at avoiding center and edge defects in the MMF 4. Once the spatial intensity distribution pattern has been selected, one or more other algorithms are performed that receive as input the selected intensity distribution pattern and perform a diffractive surface simulation algorithm that generates holograms, inserts each hologram into the simulated diffractive surface, and then selects the hologram that results in the simulated diffractive surface achieving the desired intensity distribution pattern.

Once the hologram has been selected, a diffractive surface that is suitable for use in the actual optical coupling system 10″ having the simulated design is designed and the optical coupling system 10″ is manufactured such that the surface 13a has the diffractive pattern 40 formed therein that reproduces the corresponding hologram. The diffractive pattern 40 is manufactured by mapping the phase pattern of the selected hologram into spatial variations in the thickness and/or index of refraction of a suitable substrate material of the optical coupling system 10″, which may be, for example, glass, plastic, polymers or semiconductor materials. As indicated above, photolithographic processes are well suited for forming the random spatial variations in the thickness and/or index of refraction of the substrate material.

U.S. Pat. No. 8,019,233, which issued on Sep. 13, 2011 and which is assigned to the assignee of the present application, describes methods and systems for designing and manufacturing an optical coupling system of an optical transmitter with a diffractive pattern formed therein for providing a controlled launch that avoids center and edge defects in an optical fiber. The methods and systems disclosed in that patent, which is hereby incorporated by reference herein in its entirety, are equally well suited for forming the diffractive pattern 40 in the surface 13a. Therefore, in the interest of brevity, a detailed discussion of those methods and systems will not be provided herein.

In addition to allowing MMF link length and bandwidth to be increased without increasing module complexity, the invention also provides other benefits, such as lower MMF manufacturing costs and increased yield. Because the invention allows preselected spatial intensity distributions to be achieved that avoid particular areas in the fiber that are likely to contain defects, fiber manufacturers can focus less on reducing defects in those areas and focus more on performance optimization parameters, such as fiber profile control of a, for example. For example, optical multimode (OM)1, OM2, OM3, and OM4 optical fibers are known to have center and edge defects in their cores. By relaxing tolerances associated with reducing defective areas and focusing more on performance optimization parameters, MMF performance can be improved while also improving manufacturing yield and reducing costs.

It should be noted that the invention has been described with reference to a few illustrative embodiments for the purposes of demonstrating the principles and concepts of the invention. For example, while the illustrative embodiments describe and show the first optical element 10a being located nearer to the SML light source 2 than the second optical element 10b is to the SML light source 2, the positions of the first and second optical elements 10a and 10b relative to the SML light source 2 can be reversed while providing the same optical effects described above of reducing back reflection to the SML light source 2 and controlling the launch conditions to avoid defective areas in the MMF 4. Therefore, the invention is not limited to the illustrative embodiments, as will be understood by persons of ordinary skill in the art in view of the description provided herein. Those skilled in the art will understand that modifications may be made to the embodiments described herein and that all such modifications are within the scope of the invention.

1. An optical transmitter or transceiver module comprising:
a single mode light source that produces a light beam; and
an optical coupling system, the optical coupling system being configured to receive the light beam, convert the light beam into light having a preselected spatial intensity distribution pattern, and directs the light having the preselected spatial intensity distribution pattern toward an end face of a multimode optical fiber (MMF), and wherein the preselected spatial intensity distribution pattern is preselected to avoid one or more areas in the MMF that are likely to contain defects when the light having the preselected spatial intensity distribution pattern travels through the MMF.

2. The optical transmitter or transceiver of claim 1, wherein the optical coupling system comprises a first optical element and a second optical element, and wherein the first optical element encounters the received light beam before the second optical element encounters the received light beam, and wherein the first optical element comprises an analog freeform surface that operates on the received light beam in a predetermined manner to convert the light beam into light having the preselected spatial intensity distribution pattern, and wherein the second optical element is a refractive lens that directs the light having the preselected spatial intensity distribution pattern onto the end face of the MMF.

3. The optical transmitter or transceiver of claim 2, wherein the first and second optical elements are formed in a unitary part.

4. The optical transmitter of claim 3, wherein the unitary part is a molded plastic part.

5. The optical transmitter of claim 3, wherein the unitary part is an epoxy-replicated part.

6. The optical transmitter of claim 3, wherein the unitary part is a glass part.

7. The optical transmitter of claim 3, wherein the first optical element comprises a vortex lens.

8. The optical transmitter of claim 2, wherein the first optical element reduces back reflection from the end face of the MMF into an aperture of the single mode light source by at least 10 decibels (dB).

9. The optical transmitter of claim 8, wherein the first optical element reduces back reflection from the end face of the MMF into an aperture of the single mode light source by up to 30 dB.

10. The optical transmitter of claim 2, wherein the preselected spatial intensity distribution patter is preselected to cause the light to avoid center and edge defects in the MMF.

11. The optical transmitter of claim 1, wherein the optical coupling system comprises a first optical element and a second optical element, and wherein the first optical element encounters the received light beam before the second optical element encounters the received light beam, and wherein the first optical element comprises a diffractive surface that operates on the received light beam in a predetermined manner to convert the received light beam into light having the preselected spatial intensity distribution pattern, and wherein the second optical element is a refractive lens that directs the light having the preselected spatial intensity distribution pattern onto the end face of the MMF.

12. The optical transmitter of claim 11, wherein the diffractive surface comprises a phase pattern that is manufactured based on a computer-generated hologram that achieves the preselected spatial intensity distribution pattern.

13. The optical transmitter or transceiver of claim 11, wherein the first and second optical elements are formed in a unitary part.

14. The optical transmitter of claim 11, wherein the unitary part is a molded plastic part.

15. The optical transmitter of claim 11, wherein the unitary part is an epoxy-replicated part.

16. The optical transmitter of claim 11, wherein the phase pattern comprises spatial variations in a thickness of the diffractive surface.

17. The optical transmitter of claim 11, wherein the phase pattern comprises spatial variations in an index of refraction of the diffractive surface.

18. The optical transmitter of claim 11, wherein the unitary part is a glass part.

19. The optical transmitter of claim 11, wherein the first optical element comprises a diffractive vortex lens.

20. The optical transmitter of claim 11, wherein the first optical element reduces back reflection from the end face of the MMF into an aperture of the single mode light source by at least 10 decibels (dB).

21. The optical transmitter of claim 20, wherein the first optical element reduces back reflection from the end face of the MMF into an aperture of the single mode light source by up to 30 dB.

22. A method for launching light produced by a single mode light source into an end of a multimode optical fiber (MMF), the method comprising:
with a single mode light source, producing a light beam; and
with an optical coupling system, converting the light beam into light having a preselected spatial intensity distribution pattern and directing the light having the preselected spatial intensity distribution pattern onto an end face of an MMF, and wherein the preselected spatial intensity distribution pattern is preselected to avoid one or more areas in the MMF that are likely to contain defects when the light having the preselected spatial intensity distribution pattern travels through the MMF.

23. The method of claim 22, wherein the optical coupling system reduces back reflection from the end face of the MMF into an aperture of the single mode light source by at least 10 decibels (dB).

24. The method of claim 23, wherein the optical coupling system reduces back reflection from the end face of the MMF into an aperture of the single mode light source by up to 30 dB.

25. A method for enabling a multimode optical fiber (MMF) link length and bandwidth to be increased comprising a multimode optical fiber (MMF), the method comprising:
using a single mode light source to produce a light beam to be launched into a first end face of an MMF; and
disposing an optical coupling system in between the first end face of the MMF and the single mode light source, wherein the optical coupling system is designed to convert the light beam into light having a preselected spatial intensity distribution pattern and to reduce back reflection of light from the first end face of the MMF into an aperture of the single mode light source, wherein the preselected spatial intensity distribution pattern is preselected to avoid one or more areas in the MMF that are likely to contain defects when the light having the preselected spatial intensity distribution pattern travels through the MMF; and
with the optical coupling system, receiving the light beam, converting the received light beam into light having the preselected spatial intensity distribution pattern, and directing the light having the preselected spatial intensity distribution pattern onto the first end face of an MMF.
